(19) United States
(12) Patent Application Publication
(10) Pub. No.: US 2025/0142023 A1
(43) Pub. Date: May 1, 2025

(54) HIDDEN CAMERA SUBSYSTEM THAT MONITORS A DRIVER OF A VEHICLE

(71) Applicant: VISTEON GLOBAL TECHNOLOGIES, INC., Van Buren Township, MI (US)

(72) Inventors: Elijah Louis Auger, Farmington Hills, MI (US); James Arthur Carpenter, Eagle, MI (US)

(73) Assignee: VISTEON GLOBAL TECHNOLOGIES, INC., Van Buren Township, MI (US)

(21) Appl. No.: 18/933,124

(22) Filed: Oct. 31, 2024

Related U.S. Application Data
(60) Provisional application No. 63/594,550, filed on Oct. 31, 2023.

(51) Int. Cl. H04N 7/18; G02B 5/26; G06V 20/59; H04N 23/56; H04N 23/71; H04N 23/74; H04N 23/81

(52) U.S. Cl. CPC H04N 7/183; H04N 23/56; H04N 23/71; H04N 23/74; H04N 23/81; G02B 5/26; G06V 20/597

(57) ABSTRACT

A hidden camera subsystem that monitors a driver of a vehicle includes a dashboard, a camera sensor, a reflector and a first electronic control unit. The dashboard is disposed in the vehicle. The dashboard establishes a lower sight line of the driver. The camera sensor has a field-of-view and is disposed below the lower sight line such that the camera sensor is hidden from the driver by the dashboard. The camera sensor is operational to generate a sensed video signal of a scene within the field-of-view. The reflector is disposed above the lower sight line and oriented to direct the field-of-view of the camera sensor to include a head of the driver in the scene. The first electronic control unit is operational to receive the sensed video signal and monitor the driver in response to the head of the driver within the sensed video signal.

### CROSS-REFERENCE TO RELATED APPLICATIONS

This application claims the benefit of U.S. Provisional Application No. 63/594,550 filed Oct. 31, 2023, which is hereby incorporated by reference in its entirety.

### TECHNICAL FIELD

The present disclosure generally relates to systems and methods for a hidden camera subsystem that monitors a driver of a vehicle.

### BACKGROUND

Monitoring a driver in an automotive environment generally involves a camera mounted above a dashboard to have a clear view of the driver. Such mounting arrangements may generate glare for the driver due to stray light reflecting from a lens of the camera.

### SUMMARY

A hidden camera subsystem that monitors a driver of a vehicle is provided herein. The hidden camera system includes a dashboard, a camera sensor, a reflector and a first electronic control unit. The dashboard is disposed in the vehicle. The dashboard establishes a lower sight line of the driver. The camera sensor has a field-of-view and is disposed below the lower sight line such that the camera sensor is hidden from the driver by the dashboard. The camera sensor is operational to generate a sensed video signal of a scene within the field-of-view. The reflector is disposed above the lower sight line and oriented to direct the field-of-view of the camera sensor to include a head of the driver in the scene. The first electronic control unit is operational to receive the sensed video signal and monitor the driver in response to the head of the driver within the sensed video signal.

In one or more embodiments of the hidden camera subsystem, the reflector reflects light at a plurality of polarization axes.

In one or more embodiments of the hidden camera subsystem, a filter in front of the camera sensor has a particular polarization axis, and the reflector reflects light to match the particular polarization axis.

In one or more embodiments of the hidden camera subsystem, the reflector is a portion of a windscreen of the vehicle.

In one or more embodiments of the hidden camera subsystem, the reflector is a portion of a windscreen of the vehicle.

In one or more embodiments of the hidden camera subsystem, the reflector has a curved shape.

In one or more embodiments of the hidden camera subsystem, the scene in the sensed video signal is warped by the curved shape of the reflector, and the first electronic control unit is further operational to dewarp the scene in the sensed video signal.

In one or more embodiments of the hidden camera subsystem, the reflector has a transmissivity that passes environmental light entering the vehicle through a windscreen to reach the driver at a perceptible amplitude.

In one or more embodiments, the hidden camera subsystem includes an opaque material disposed between the reflector and a windscreen of the vehicle.

In one or more embodiments of the hidden camera subsystem, the reflector and the opaque material are laterally offset from the driver such that a road on which the vehicle sits is visible to the driver looking straight ahead.

In one or more embodiments of the hidden camera subsystem, a ray of light which intersects an eye box of the driver and a windscreen of the vehicle is a mirror angle of an axis of the camera sensor.

In one or more embodiments of the hidden camera subsystem, the dashboard has a cavity and the camera sensor is disposed in the cavity.

In one or more embodiments of the hidden camera subsystem, the first electronic control unit is operational to generate output data in one or more control signals based on the sensed video signal.

In one or more embodiments, the hidden camera subsystem includes a display subsystem in communication with the first electronic control unit and operational to generate a plurality of visible images in response to the output data received in the one or more control signals.

In one or more embodiments, the hidden camera subsystem includes one or more illuminators in communication with the first electronic control unit and operational to generate an illumination light, wherein the illumination light shines on the scene.

In one or more embodiments, the hidden camera subsystem includes an ambient light sensor in communication with the first electronic control unit and operational to measure an ambient light level of the scene.

A vehicle is provided herein. The vehicle includes a seat for a driver, a dashboard, a camera, a reflector, and a first electronic control unit. The dashboard is disposed in front of the seat and establishes a lower sight line of the driver in the seat. The camera sensor has a field-of-view and is disposed below the lower sight line such that the camera sensor is hidden from the driver by the dashboard. The camera sensor is operational to generate a sensed video signal of a scene within the field-of-view. The reflector is disposed above the lower sight line and is oriented to direct the field-of-view of the camera sensor to include a head of the driver in the scene. The first electronic control unit is operational to receive the sensed video signal and monitor the driver in response to the head of the driver within the sensed video signal.

In one or more embodiments of the vehicle, the first electronic control unit is operational to generate output data in one or more control signals based on the sensed video signal.

In one or more embodiments, the vehicle includes a display subsystem in communication with the first electronic control unit and operational to generate a plurality of visible images in response to the output data received in the one or more control signals.

In one or more embodiments, the vehicle includes a second electronic control unit operational to determine one or more conditions of the driver based on the sensed video signal.

The above features and advantages and other features and advantages of the present teachings are readily apparent from the following detailed description of the best modes for carrying out the teachings when taken in connection with the accompanying drawings.

### BRIEF DESCRIPTION OF THE DRAWINGS

FIGS. 1 and 2 illustrate a hidden camera subsystem in a vehicle in accordance with one or more exemplary embodiments.

FIG. 3 illustrates a flow diagram of a method of operation in accordance with one or more exemplary embodiments

The present disclosure may have various modifications and alternative forms, and some representative embodiments are shown by way of example in the drawings and will be described in detail herein. Novel aspects of this disclosure are not limited to the particular forms illustrated in the above-enumerated drawings. Rather, the disclosure is to cover modifications, equivalents, and combinations falling within the scope of the disclosure as encompassed by the appended claims.

### DETAILED DESCRIPTION

Embodiments of the disclosure generally provide a system and/or a method for a hidden camera subsystem that monitors a driver of a vehicle. The system/method may detect one or more aspects (or pertinent driver information) of the driver through the camera subsystem, where the camera subsystem is not visible to the driver and/or other occupants. The camera subsystem is embedded in the vehicle, hidden from direct view of the driver. The camera subsystem includes a dashboard, a camera sensor, a reflector, and a first electronic control unit.

The camera sensor receives a reflection of the driver from a fully or partially reflective surface. A sensed (or raw or initial) video signal of the driver reflection is generated and presented by the camera sensor. The driver reflection generally includes at least a head of the driver, including the eyes and eyelids of the driver.

In various embodiments, the reflective surface is combined with a windscreen (e.g., a windscreen) of the vehicle. In other embodiments, the reflective surface is separate from the windscreen. The reflective surface may be reflective to all polarizations of light, or may be reflective only in a particular polarization axis that is aligned to (or matches) a filter ahead of the camera sensor, thereby reducing further detectability of the camera sensor by the driver and other occupants.

An electronic control unit is operational to perform image processing capabilities to interpret driver behaviors and/or other pertinent characteristics.

The camera subsystem may include a display subsystem embedded in the vehicle. The display subsystem is operational to generate a virtual and/or a reflected image plane that is observable by the driver solely or by the driver and the other occupants.

In various embodiments, the camera subsystem is standalone. The sensed video signal generated by the camera sensor is transferred to the electronic control unist for processing. Output data generated by the first electronic control unit in response to the sensed video signal is transferred in one or more control signals to the display subsystem. The display subsystem presents the output data to the driver and/or the other occupants of the vehicle.

In some embodiments, the sensed video signal generated by the camera is also presented to a computer that is external to the camera subsystem. The computer is operational to perform image processing of the sensed video signal to generate additional output data. The additional output data may be transferred to other electronics within the vehicle to take action based on the perceived driver behaviors and/or other pertinent characteristics.

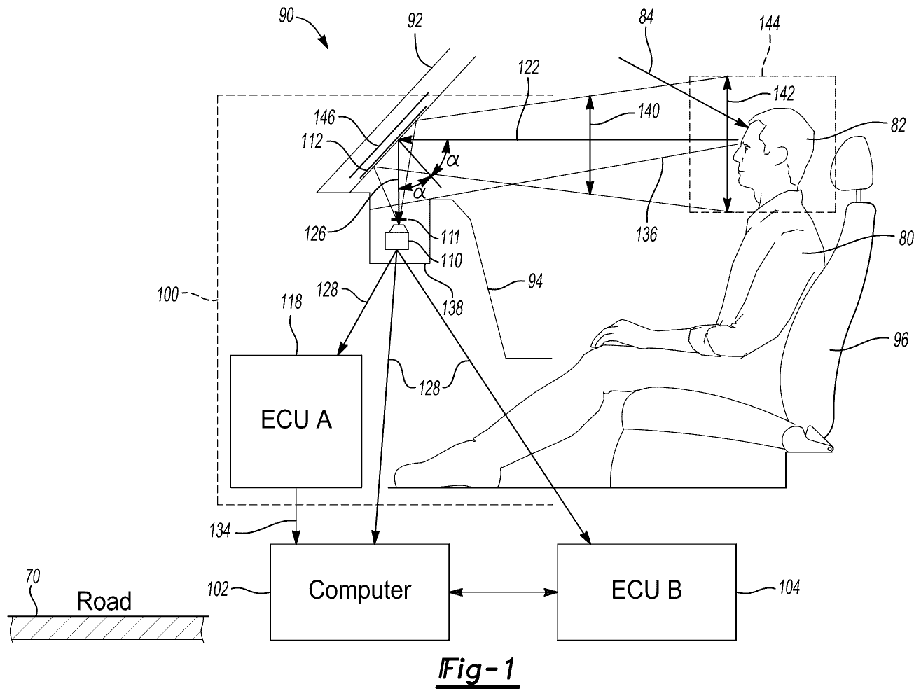

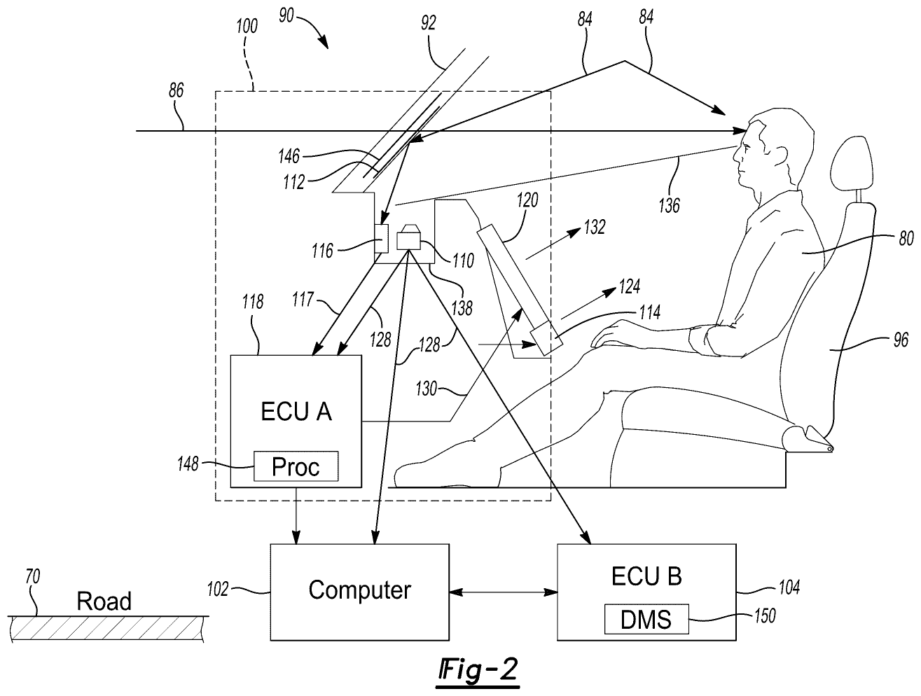

FIGS. 1 and 2 illustrate a hidden camera subsystem in a vehicle in accordance with one or more exemplary embodiments. The vehicle 90 generally includes at least a windscreen 92, a dashboard 94, a seat 96 for a driver 80, a camera subsystem 100, a computer 102, and a (second) electronic control unit (ECU B) 104. The camera subsystem 100 includes the dashboard 94, a camera sensor 110, a reflector 112, one or more illuminators 114, an optional ambient light sensor 116, and a (first) electronic control unit (ECU A) 118. In some embodiments, the camera subsystem 100 includes a display subsystem 120.

The vehicle 90 is operational to carry a driver 80 and possibly one or more passengers. The vehicle 90 may include mobile vehicles such as automobiles, trucks, motorcycles, boats, trains and/or aircraft. Other types of vehicles may be implemented to meet the design criteria of a particular application.

The driver 80 is shown sitting in the seat 96 of the vehicle 90 behind the display subsystem 120. In various embodiments, a passenger sitting in another seat may be positioned to view the display subsystem 120. The driver 80 has a head 82 (or face) with eyes, eyelids, and a mouth. Ambient light 84 inside the vehicle 90 and striking the head 82 of the driver 80 creates a driver optical image (DOI) 122 moving in a direction toward the windscreen 92 and the reflector 112. Infrared light 124 generated by the illuminators 114 and/or environmental light 86 entering the vehicle 90 through the windscreen 92 may also strike the head 82 of the driver 80 to create or add to the driver optical image 122.

The camera subsystem 100 is operational to monitor the driver 80. The camera subsystem 100 is operational to receive a reflected optical image 126 of at least the head 82 (or face) of the driver 80. The reflected optical image 126 is converted into a sensed video signal 128 within the camera subsystem 100. The camera subsystem 100 subsequently processes the reflected optical image 126 in the sensed video signal 128 to generate one or more control signals 130. Output data in the control signals 130 may be presented to the display subsystem 120 for presentation as one or more visible images 132 to the driver 80. In various embodiments, the sensed video signal 128 and/or one or more processed signals 134 may be presented to circuitry that is external to the camera subsystem 100. In some embodiments, the external circuitry may include one or more computers 102 and/or a second electronic control units 104.

The dashboard 94 may implement a structure in the vehicle 90 disposed between the camera sensor 110 and the driver 80 (e.g., in front of the seat 96). The dashboard 94 generally establishes a lower sight line 136 (or line-of-sight) of the driver 80 looking forward. In various embodiments, the dashboard 94 may include a cavity 138. The camera sensor 110 is disposed within or behind the dashboard 94 and below the lower sight line 136 such that the camera sensor 110 is hidden from the driver 80.

The camera sensor 110 has a field-of-view 140 that spans a scene 142. The driver 80 is normally seated within the field-of-view 140. The camera sensor 110 also has a camera axis that is centered within the field-of-view 140. The camera axis intersects the reflector 112.

The camera sensor 110 is positioned in the vehicle 90 relative to the seat 96 with some or most of the dashboard 94 therebetween. A vertical position of the camera sensor 110 is below the lower sight line 136 of the driver 80 such that a tallest anticipated driver 80 cannot see the camera sensor 110 due to the dashboard 94. The camera sensor 110 is operational to convert the reflected optical image 126 (e.g., a reflected version of a driver optical image 122) into the sensed video signal 128. The sensed video signal 128 is presented to the first electronic control unit 118. In various embodiments, the sensed video signal 128 is also presented to the external circuitry (e.g., the computer 102 and/or the second electronic control unit 104).

The camera sensor 110 is oriented such that a ray of light intersecting a driver eye box 144 and the windscreen 92 is at a mirror angle (a) of a camera axis. The camera sensor 110 may be mounted in a cavity 138 of the dashboard 94 below the lower sight line 136 of the driver 80. The cavity 138, together with the optional dark reflector 112 may serve to create a sort of shadowbox around the camera sensor 110, thereby further hiding the camera sensor 110 from view. In various embodiments, the reflector 112 may be configured to solely reflect a polarization axis of interest and one or more filters 111 (e.g., polarizer, analyzer, infrared pass and/or visible blocking) may be included in front of the camera sensor 110 (or integrated into the camera sensor 110). Therefore, stray light incident on the filter 111 is extinguished by the reflector 112 and not be reflected back to the driver 80, thus further obscuring the camera sensor 110 from detection. The stray light may arise from direct exposure to sunlight, reflections of the sunlight, other lights around the vehicle 90 (e.g., streetlights), lights within the vehicle 90 (e.g., dome lights), other vehicle headlights, and the like.

The reflector 112 implements a reflective surface or a reflective object. The reflector 112 may have a transmissivity that passes environmental light 86 entering the vehicle 90 through a windscreen 92 to reach the driver 80 at a perceptible amplitude. In some embodiments, the reflector 112 may be reflective to visible light at all polarization axes. In other embodiments, the reflector 112 may be reflective to light only in a polarization axis that is aligned to the polarization axis of the filter 111. In other embodiments, the reflective surface redirects light based on wavelength. For example, particular primary colors may be highly reflected while other colors are not reflected to the same extent as the primary colors.

The reflector 112 may be a portion of the windscreen 92, attached to a surface (e.g., an inner surface, an intermediate surface, or an outer surface) of the windscreen 92, or be a separate item from the windscreen 92. In implementations where the reflector 112 is separate from the windscreen 92, the reflective surface of the reflector 112 may be flat or may be geometrically shaped (e.g., a curved shape). The curved shape of the reflective surface generally warps the scene 142 in the reflected optical image 126.

In various embodiments, the reflective surface may be of low reflectivity, such that the mirroring technology, whether film, deposited coating, or other, is uniformly applied to the windscreen 92 without impinging on a transmissivity of light through the windscreen 92. Where a low-reflection, high transmission coating is applied to the windscreen 92, an opaque material 146 may be also applied to a surface of the windscreen 92 behind the reflective surface to create a “black mirror” effect. In other words, the reflective surface redirects the light, but the background appears to an observer (e.g., the driver 80) to be black rather than a normal silver or white. The opaque material 146 may be positioned to be viewable by the driver 80, but not so tall as to block the driver's sight lines of a road 70 and other viewable objects outside of the vehicle 90. In some embodiments, the reflector 112 and the opaque material 146 may be laterally offset from the driver 80 (e.g., offset to the drier's left or offset right) such that the driver 80 may see the road 70, unobstructed by the reflector 112 or the opaque material 146, while looking straight ahead. Additional details of embodiments of the reflector 112 and/or the opaque material 146 may be found in co-pending U.S. Provisional Application No. 63/682,782, filed Aug. 13, 2024, which is hereby incorporated by reference in its entirety.

The first electronic control unit 118 implements one or more image-processing circuits 148 and one or more display-driver circuits. The first electronic control unit 118 is generally operational to generate the control signals 130 that drive the display subsystem 120. In various embodiments, the control signals 130 may be configured to provide instrumentation (e.g., speed, tachometer, fuel, temperature, etc.) to at least one of the display subsystem 120. In some embodiments, the control signals 130 may also be configured to provide video (e.g., a rear-view camera video, a forward-view camera video, an onboard DVD player, etc.) to the display subsystem 120. In other embodiments, the control signals 130 may be further configured to provide alphanumeric information shown on the display subsystem 120. The first electronic control unit 118 may also implement an image-dewarping technique that corrects the reflected optical image 126 to account for a curvature of the windscreen 92, and/or the reflector 112 in cases where the reflective surface is not flat. Other image processing techniques may be implemented to meet the design criteria of a particular application.

The second electronic control unit 104 implements a driver monitoring system 150. The driver monitoring system 150 is generally operational to monitor one or more aspects of the driver 80 based on a posture of the head 82 of the driver 80, a gaze direction of the eyes of the driver 80, open/closed status of the eyelids of the driver 80, movement of the mouth of the driver 80, and the like. The driver monitoring system 150 may generate a caution signal (e.g., physical, optical, acoustic and/or hepatic) upon determining that the driver 80 is not alert and driving carefully.

In various embodiments, the first electronic control unit 118 and the second electronic control unit 104 generally comprises at least one microcontroller. The at least one microcontroller may include one or more processors, each of which may be embodied as a separate processor, an application specific integrated circuit (ASIC), a field programmable gate array (FPGA), or a dedicated electronic circuitry. The at least one microcontroller may be any sort of electronic processor (implemented in hardware, software executing on hardware, or a combination of both). The at least one microcontroller may also include tangible, non-transitory memory, (e.g., read-only memory in the form of optical, magnetic, and/or flash memory). For example, the at least one microcontroller may include application-suitable amounts of random-access memory, read-only memory, flash memory and other types of electrically-erasable programmable read-only memory, as well as accompanying hardware in the form of a high-speed clock or timer, analog-to-digital and digital-to-analog circuitry, and input/output circuitry and devices, as well as appropriate signal conditioning and buffer circuitry.

Computer-readable and executable instructions embodying the present method may be stored in the memory and executed as set forth herein. The executable instructions may be a series of instructions employed to run applications on the at least one microcontroller (either in the foreground or background). The at least one microcontroller may receive commands and information, in the form of one or more input signals from various controls or components in the vehicle 90 and communicate instructions to the display subsystem 120 through the control signals 130.

The display subsystem 120 is generally mounted to the dashboard 94. The display subsystem 120 is operational to generate the visible images 132 in response to the control signals 130 received from the first electronic control unit 118. The visible images 132 are directed toward the driver 80. In some embodiments, the display subsystem 120 may be a cluster display positioned for use by the driver 80. The display subsystem 120 may be, or include, a console display positioned for use by the driver 80 and a passenger and/or a passenger display positioned for use by the passenger.

The illuminators 114 are operational to generate an illumination light (e.g., infrared light 124) that is directed toward and illuminates the scene 142/driver 80. Control of the illuminators 114 is provided by the first electronic control unit 118 through the control signals 130. In various embodiments, the illuminators 114 may be disposed within the cavity 138 of the dashboard 94 and/or on the dashboard 94 (as illustrated) neighboring the display subsystem 120. In various embodiments, the illuminators 114 may be located adjacent the camera sensor 110 and oriented so that the illuminating infrared light 124 is directed upwards parallel to the camera axis. The infrared light 124 is subsequently redirected by the reflector 112 to shine on the scene 142/driver 80. Other locations of the illuminators 114 may be implemented to meet the design criteria of a particular application.

The ambient light sensor 116 may be located below the lower sight line 136 and in communication with the first electronic control unit 118. In some cases, the ambient light sensor 116 may be disposed in the cavity 138 of the dashboard 94 and adjoining the camera sensor 110. The ambient light sensor 116 is operational to measure the ambient light 84 being reflected by the reflector 112 from an interior of the vehicle 90 (e.g., the scene 142/driver 80) toward the camera sensor 110. The ambient light level may be transferred to the first electronic control unit 118 in a light sensor signal 117. The first electronic control unit 118 may use the ambient light level detected by the ambient light sensor 116 to adjust the driver monitoring system as the scene 142 varies from bright ambient conditions to near total darkness conditions. In some situations, the first electronic control unit 118 uses the detected ambient light level to adjust an exposure setting of the camera sensor 110, where not already built-in to the camera sensor 110.

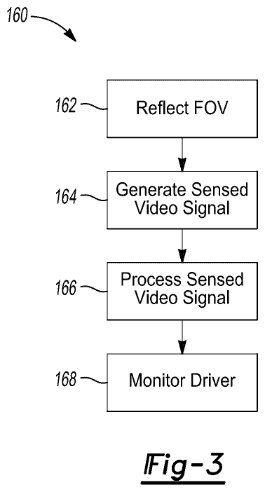

FIG. 3 illustrates a flow diagram of a method of operation in accordance with one or more exemplary embodiments. The method 160 (or process) generally includes steps 162 to 168, as illustrated. Other sequences of steps may be implemented to meet the design criteria of a particular application.

In the step 162, the reflector 112 is disposed above the lower sight line 136 directs the field-of-view 140 of the camera sensor 110 to include the head 82 of the driver 80 and/or the scene 142. In the step 164, the camera sensor 110 is operational to generate the sensed video signal 128 of the scene 142 within the field-of-view 140 with the camera sensor 110. The camera sensor 110 is disposed below the lower sight line 136 of the driver 80 such that the camera sensor 110 is hidden from the driver 80 by the dashboard 94. The dashboard 94 establishes the lower sight line 136 of the driver 80.

In the step 166, the sensed video signal 128 is processed (e.g., dewarped, decompressed, color corrected, filtered, and so on). In the step 168, the first electronic control unit 118 monitors the driver 80 in response to the head 82 of the driver 80 within the sensed video signal 128.

Those having ordinary skill in the art will recognize that terms such as “above,” “below,” “front,” “back,” “upward,” “downward,” “top,” “bottom,” etc., may be used descriptively herein without representing limitations on the scope of the disclosure. Furthermore, the present teachings may be described in terms of functional and/or logical block components and/or various processing steps. Such block components may be comprised of various hardware components, software components executing on hardware, and/or firmware components executing on hardware.

The foregoing detailed description and the drawings are supportive and descriptive of the disclosure, but the scope of the disclosure is defined solely by the claims. As will be appreciated by those of ordinary skill in the art, various alternative designs and embodiments may exist for practicing the disclosure defined in the appended claims.

1. A hidden camera subsystem that monitors a driver of a vehicle, comprising:
a dashboard disposed in the vehicle, wherein the dashboard establishes a lower sight line of the driver;
a camera sensor with a field-of-view and being disposed below the lower sight line such that the camera sensor is hidden from the driver by the dashboard, wherein the camera sensor is operational to generate a sensed video signal of a scene within the field-of-view;
a reflector disposed above the lower sight line and oriented to direct the field-of-view of the camera sensor to include a head of the driver in the scene; and
a first electronic control unit operational to receive the sensed video signal and monitor the driver in response to the head of the driver within the sensed video signal.

2. The hidden camera subsystem according to claim 1, wherein:
the reflector reflects light at a plurality of polarization axes.

3. The hidden camera subsystem according to claim 1, wherein:
a filter in front of the camera sensor has a particular polarization axis; and
the reflector reflects light to match the particular polarization axis.

4. The hidden camera subsystem according to claim 1, wherein:
the reflector is a portion of a windscreen of the vehicle.

5. The hidden camera subsystem according to claim 1, wherein:
the reflector is separate from a windscreen of the vehicle.

6. The hidden camera subsystem according to claim 1, wherein:
the reflector has a curved shape.

7. The hidden camera subsystem according to claim 6, wherein:
the scene in the sensed video signal is warped by the curved shape of the reflector; and
the first electronic control unit is further operational to dewarp the scene in the sensed video signal.

8. The hidden camera subsystem according to claim 1, wherein:
the reflector has a transmissivity that passes environmental light entering the vehicle through a windscreen to reach the driver at a perceptible amplitude.

9. The hidden camera subsystem according to claim 1, further comprising:
an opaque material disposed between the reflector and a windscreen of the vehicle.

10. The hidden camera subsystem according to claim 9, wherein:
the reflector and the opaque material are laterally offset from the driver such that a road on which the vehicle sits is visible to the driver looking straight ahead.

11. The hidden camera subsystem according to claim 1, wherein:
a ray of light which intersects an eye box of the driver and a windscreen of the vehicle is a mirror angle of an axis of the camera sensor.

12. The hidden camera subsystem according to claim 1, wherein:
the dashboard has a cavity and the camera sensor is disposed in the cavity.

13. The hidden camera subsystem according to claim 1, wherein:
the first electronic control unit is operational to generate output data in one or more control signals based on the sensed video signal.

14. The hidden camera subsystem according to claim 13, further comprising:
a display subsystem in communication with the first electronic control unit and operational to generate a plurality of visible images in response to the output data received in the one or more control signals.

15. The hidden camera subsystem according to claim 1, further comprising:
one or more illuminators in communication with the first electronic control unit and operational to generate an illumination light, wherein the illumination light shines on the scene.

16. The hidden camera subsystem according to claim 1, further comprising:
an ambient light sensor in communication with the first electronic control unit and operational to measure an ambient light level of the scene.

17. A vehicle comprising:
a seat for a driver;
a dashboard disposed in front of the seat, wherein the dashboard establishes a lower sight line of the driver in the seat;
a camera sensor with a field-of-view and being disposed below the lower sight line such that the camera sensor is hidden from the driver by the dashboard, wherein the camera sensor is operational to generate a sensed video signal of a scene within the field-of-view;
a reflector disposed above the lower sight line and oriented to direct the field-of-view of the camera sensor to include a head of the driver in the scene; and
a first electronic control unit operational to receive the sensed video signal and monitor the driver in response to the head of the driver within the sensed video signal.

18. The vehicle according to claim 17, wherein:
the first electronic control unit is operational to generate output data in one or more control signals based on the sensed video signal.

19. The vehicle according to claim 18, further comprising:
a display subsystem in communication with the first electronic control unit and operational to generate a plurality of visible images in response to the output data received in the one or more control signals.

20. The vehicle according to claim 17, further comprising:
a second electronic control unit operational to determine one or more conditions of the driver based on the sensed video signal.
